(19) United States
(12) Patent Application Publication
(10) Pub. No.: US 2019/0264726 A1
(43) Pub. Date: Aug. 29, 2019

(54) Mantle Clamp Configuration

(71) Applicants: Caleb Hunter, Queen Creek, AZ (US); Benjamin Hunter, Gilbert, AZ (US); Matthew Hunter, Gilbert, AZ (US)

(72) Inventors: Caleb Hunter, Queen Creek, AZ (US); Benjamin Hunter, Gilbert, AZ (US); Matthew Hunter, Gilbert, AZ (US)

(21) Appl. No.: 16/289,605

(22) Filed: Feb. 28, 2019

Related U.S. Application Data
(60) Provisional application No. 62/636,692, filed on Feb. 28, 2018.

(51) Int. Cl. F16B 37/14

(52) U.S. Cl. CPC F16B 37/14; B02C 2/00

(57) ABSTRACT

A mantle clamp configuration designed to lock the mantle in place on a rock crusher includes a clamp plate assembly with a clamp plate with holes; a plurality of clamp bolts that are inserted through the holes; and optionally a dust cover with dust cover bolts. The configuration also may also include modified original equipment manufacturer (OEM) assembly including modified locking collar; new locking collar bolts to accept the clamp bolts; and burn ring modified to fit the overlying clamp plate.

### TECHNICAL FIELD

This application relates generally to rock crushers and particularly to replacement for rock crusher nuts to secure the mantle in place.

### BACKGROUND

The mining industry has a centuries-long history and tradition of performing some of the toughest, most dangerous jobs. The US Mine Safety and Health Administration was only created in 1978, but now tracks fatalities by facility and contractor. Because most mining activities are performed outside of urban centers, injuries cannot be treated promptly, which also contributes to mortality.

After rock with valuable minerals is obtained from the ground, the next step is often crushing and grinding to particular sizes of rock, enabling efficient processing. Crushers also have been around a long time, with few changes in technology in recent decades. Crushing equipment, built to withstand and process rocks, lasts decades. Sealing of the equipment limits contamination of the oil reservoir and damage to critical mechanical parts. However, over time, the equipment needs to be cleaned, repaired and resealed.

### SUMMARY

In one embodiment, there is disclosed a mantle clamp configuration designed to lock the mantle in place on a rock crusher. The configuration has a mantle clamp assembly with a) a clamp plate with holes, b) a plurality of clamp bolts that are inserted through the holes and c) optionally a dust cover with dust cover bolts. The configuration also has modified original equipment manufacturer (OEM) assembly with a) modified locking collar, b) new locking collar bolts to accept the clamp bolts and c) wear ring modified to fit the overlying clamp plate.

Optionally, the new mantle clamp configuration has a dust cover that covers the clamp bolts and is held in place by dust cover bolts. In another option, the wear ring is omitted from the mantle clamp configuration.

In another embodiment, a mantle clamp configuration designed to lock the mantle in place on a rock crusher has a) an inner nut installed above the mantle and head, the inner nut having a plurality of holes to accept a plurality of clamp bolts, b) an outer wear ring that slides over the inner nut; and c) a clamp plate assembly. The clamp plate assembly has a clamp plate with a top and a bottom, the bottom having a plurality of holes and a plurality of clamp bolts.

Optionally this embodiment has a hollow clamp plate with a wider top surface and a narrower lower portion to fit inside the outer wear ring. In another option, the clamp plate has a hollow central cylinder, where clamp bolts are accessed. Optionally, the wider top surface of the clamp plate supports a feed plate.

In yet another embodiment, a mantle clamp configuration locks a mantle in place on a rock crusher with a) an inner nut with its inside circumference threaded to fit an OEM head and a top with a plurality of holes to receive clamp bolts, b) a wear ring with a larger circumference than the inner nut and designed to slide over and protect the inner nut, c) a cover plate that sits within the raised sides of the feed plate and covers and protects the clamp bolts and d) a feed plate assembly. The feed plate assembly has a feed plate with raised edges and a central lifting eye and a plurality of clamp bolts that project downward from the feed plate and that are screwed into the inner nut.

In yet another embodiment, a mantle clamp configuration to lock a mantle in place on a rock crusher. This configuration has an inner bolt sized to fit in a hollow, threaded OEM head having a top surface with a plurality of holes to accept clamp bolts; and a feed plate assembly with a feed plate with raised edges and a plurality of holes and a plurality of clamp bolts that enter the feed plate holes and are screwed into the holes in the inner bolt.

### BRIEF DESCRIPTION OF DRAWINGS

The accompanying drawings are included to provide a further understanding of the invention and are incorporated in and constitute a part of this specification, illustrate embodiments of the invention, and together with the description, serve to explain the principles of the invention.

FIG. 1 shows a cross-sectional view of a gyratory crusher having a main shaft in a stationary bowl and a mantle clamp assembly at the top center.

FIGS. 2A, 2B and 2C are schematic drawings of an exploded view of a new mantle clamp assembly FIG. 2A, a cross-sectional view with the new embodiment on the left and the OEM version on the right FIG. 2B, and a partial cross section showing the forces that lock the mantle in place FIG. 2C.

FIGS. 3A and 3B are schematic drawings of an exploded view of a different embodiment of the mantle clamp assembly in an exploded view FIG. 3A and a cross-sectional view with the new embodiment on the left and the earlier version on the right FIG. 3B.

FIGS. 4A and 4B are schematic representations that show an exploded view of parts FIG. 4A and a cross-sectional view of the new embodiment of the mantle clamp assembly on the left and the earlier OEM version on the right FIG. 4B.

FIGS. 5A and 5B are schematics showing an exploded view of yet another embodiment of the mantle clamp assembly FIG. 5A and a cross-sectional view representing the in situ arrangement of the new embodiment on the left and the OEM product on the right FIG. 5B.

FIGS. 6A and 6B are schematics showing an exploded view of yet another embodiment of the mantle clamp assembly FIG. 6A and a cross-sectional view representing the in situ arrangement of the new embodiment on the left and the OEM product on the right FIG. 6B.

### DETAILED DESCRIPTION

We have visited multiple mines in different parts of the world and observed processes. In particular, we observed carefully as personnel relined their crushers. Crushers need to be taken apart and reassembled when, for example, too-large rocks get stuck between chambers. That can occur with large rocks entering the crusher or by large fragments getting stuck on top of or before the screen to size the rock fragment output. Each time, the mantle and main shaft need to be removed and re-aligned with the eccentric bushing.

We have been building torque bolt crusher nuts to lock in place the mantles of gyratory and cone crushers for about 15 years. These utilize jack screws and replaceable parts for the rebuild. The torque bolt design makes it possible to consistently tighten a mantle on the main shaft without heavy pounding or using very large torque multipliers. Cost however is higher. Moreover, wear has become noticed as a problem.

A previous customer had adapted our successful torque bolt design in an effort to improve wear characteristics; however, the complexity of their solutions has proven to be a problem. We have also had customers ask for improved longevity and decreased wear, which we have been working on. For a while our attempts to modify our earlier design increased the cost of the items that wear out.

Recently we attempted to build a new torque bolt crusher nut for a Symons 7-foot Shorthead Cone Crusher. This unit proved particularly difficult to design and build, as there is very little space for the nut to sit. Furthermore, the rocks flow over the nut causing a high level of wear. Moreover, the nut threads are double lead-in, left-handed buttress threads, making the nut difficult and expensive to build. To limit expense, we used replaceable parts and the threading on the existing main shaft threads.

Ultimately this prototype increased the nut to the point of it choking the crusher's rock feed. With that failure, we reviewed the design and invented a much smaller profile, even smaller than the OEM nut, while improving the wear characteristics of the nut. We invented a way to make the regularly replaced parts more simple to build. Importantly the new parts can be forged or cast from a wide range of alloys. Since beginning our invention, we have found our new design to be adaptable to similar mantle clamp assemblies for a much wider range of crusher styles and sizes than with our earlier design.

We have found that we solve many problems with the new invention. Chief among these is reducing the replacement costs of complicated, expensive threaded bolts and nuts. Moreover, these threaded bolts and nuts have become jammed, requiring burning and cutting thereof; the burning and cutting can damage the main shaft, whose replacement is even more expensive and time consuming.

As mentioned above, frequently crusher nuts have worn out because they are in the path of the material flow and are constantly abraded. Worse yet, current designs cannot be made of wear-resistant materials because of the manufacturing processes involved. Specifically, the necessary threads cannot readily be cut into abrasive-resistant materials. The low-dimensional tolerances of castings of other alloys like manganese mixtures do not allow their replacing current materials.

When the crusher design requires low-profile crusher nuts, there has been no room for implementation of jack screws or wear covers to improve wear of crusher nuts.

Pounding and tightening current large crusher nuts has resulted in injury and even death because the swinging heavy weights (battering rams) also need to be guided by human hands.

Due to friction and the dirty working environment of crushers, it has proven very difficult to guarantee that current crusher nuts are tight enough without being too tight. When the nut is tightened incorrectly, the mantle can break loose, causing injury or death of operators. Then the mantle is also damaged and causes millions of dollars in downtime. Our inventive design enables precise and easily measured torque values to be obtained. With our new design, downtime is decreased, as the nut is more efficiently installed and strongly tightened.

Sometimes the top of the mantle surface is not square to the crusher nut threads, which interferes with tightening the threads and/or leaves the mantle insufficiently tightened. Our invention solves this problem that may not be discovered until the very large crusher nut assembly has been shipped hundreds of miles, wasting expensive down time. Our mantle clamp can be tightened so that it sits at a slight angle relative to the main shaft to match a skewed or misplaced top surface of the mantle.

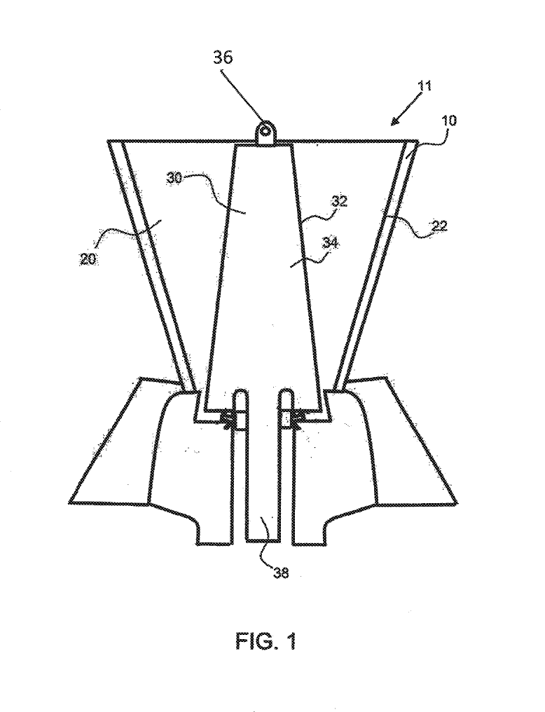

Turning now to the details of the invention, we provide a schematic cross section of one embodiment of a rock crusher in FIG. 1 that depicts the basics of a gyratory crusher 11. There is an outer bowl 20 into which large rocks are deposited. The rocks occupy the space between the bowl 20 and the mantle 32. Inside the mantle 32 is the main shaft 30 of the rock crusher. At the top of the mantle 32 is shown a marker 36 that represents the location of the prior crusher nuts to stabilize the mantle 32 and of our inventive clamp ring design (shown in other drawings). The following drawings show a variety of inventions for various crusher designs. The adaptability of our inventions is another advantage that we discovered.

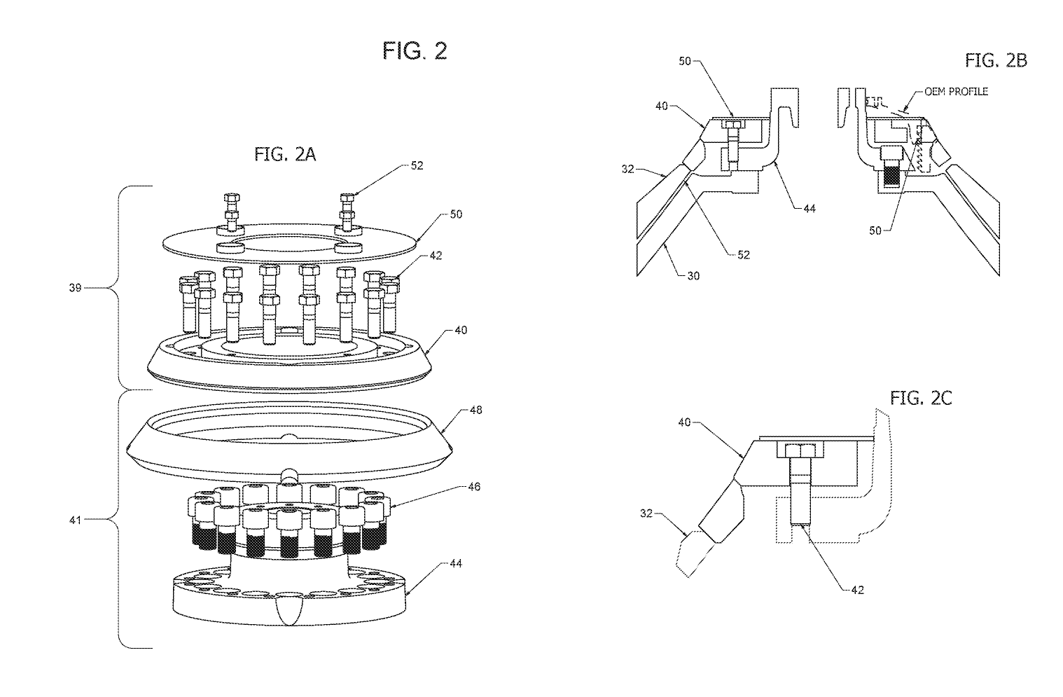

FIGS. 2A, 2B and 2C illustrate schematically the differences between the old-style Impactful, cover plate and burn ring with the inventive torque-bolt design that eliminates the unsafe and labor-intensive practices of “pounding” and “burning.” Another advantage is that this embodiment is 400 pounds lighter than the OEM configuration, providing not only less transportation cost but also easier handling by personnel. FIG. 2A is a schematic exploded view that shows a new mantle clamp assembly 39 for use with our modified Symons 7′ SH parts 41. The assembly 39 includes the clamp plate 40, clamp bolts 42, and cover plate 50 with its protected cover plate bolts. The clamp bolts 42 are torqued to apply downward pressure on the clamp plate 40 and lock the mantle in place. For later removal of the clamp ring assembly 39, the clamp bolts 42 are simply backed out.

The inventively modified parts 41 include the modified locking collar 44, new replacement locking collar bolts 46 and the burn ring 48.

FIG. 2B is a schematic cross section that shows the inventive mantle clamp apparatus assembled on the left and OEM parts on the right. The modified locking collar 44 can be compared with the OEM collar on the right. As can also be seen by comparison, the cover plate 50 is new and helps the apparatus withstand the barrage of rocks longer. The backing material 52 is shown.

FIG. 2C is a schematic illustration of how the mantle clamp accomplishes the task better. When the clamp bolt 42 is tightened, it pulls down the clamp plate, which securely holds the mantle 32 in place.

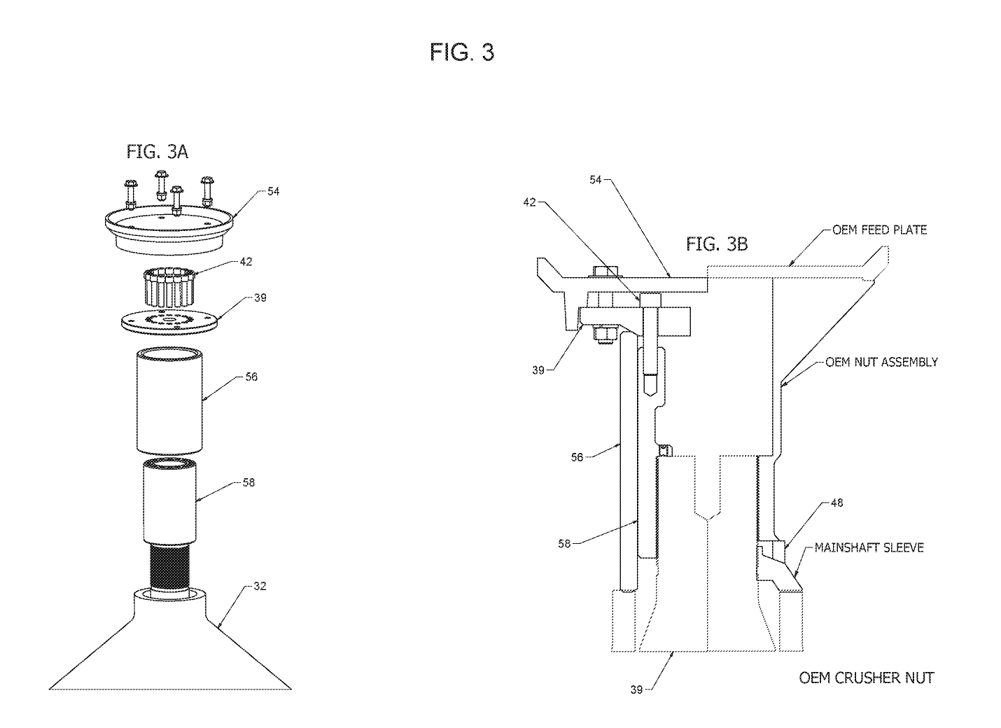

FIGS. 3A and 3B show another inventive design for a mantle clamp for use on the Symon's 7′ crusher. FIG. 3A is an exploded diagram, showing the feed plate 54, clamp plate 39, a wear ring 56, and inner nut 58 that are installed above the mantle 32 and head.

FIG. 3B compares the inventive mantle clamp assembly and the OEM crusher nut assembly. Note that the inventive design has no burn ring 48, which makes the apparatus installation and removal safer. The inner nut 58 is semi-permanently installed on the head and remains there even during the rebuild. It accommodates the clamp plate 39. The wear ring 56 slides over the inner nut 58 for improved wear resistance and low replacement cost, as it functions without expensive threading. The clamp plate 39 bolts down to the inner nut 58 to lock the mantle 32 in place. The clamp bolts 42 are torqued to apply downward pressure on the clamp ring 40 and lock the mantle 32 in place. The clamp plate 39 has a top face 62 on which the feed plate 54 sits.

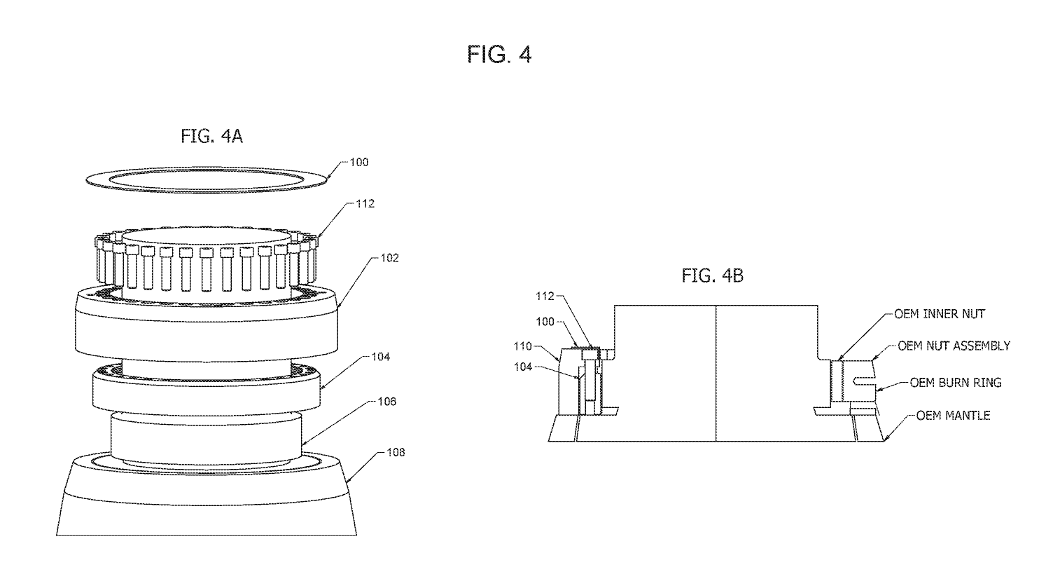

In another embodiment, FIGS. 4A and 4B show a new design for a gyratory crusher nut assembly. FIG. 4A is an exploded view of a cover plate 100, mantle clamp assembly 102, inner nut 104, OEM head 106 and mantle 108. The inner nut 104 is semi-permanently installed to rest on the head during rebuild.

FIG. 4B is a schematic cross section comparing the new embodiment on the left and the OEM design on the right. Note that this embodiment does not have a burn ring and is thus safer. Not shown on the OEM side are the threads on the inner nut and outer nut, which require the use of softer material that wears out faster. There are no threads on the right, enabling a longer crusher nut assembly. The mantle clamp 110 slides down and covers the inner nut 104. The inner nut 104 is circular and has a thickness whose outer diameter is slightly narrower than the mantle 108 opening. Clamp bolts 112 are inserted into the clamp plate 110 and screwed into holes in the inner nut 104. The cover plate 100 is welded or bolted on top to protect the clamp bolts from wear.

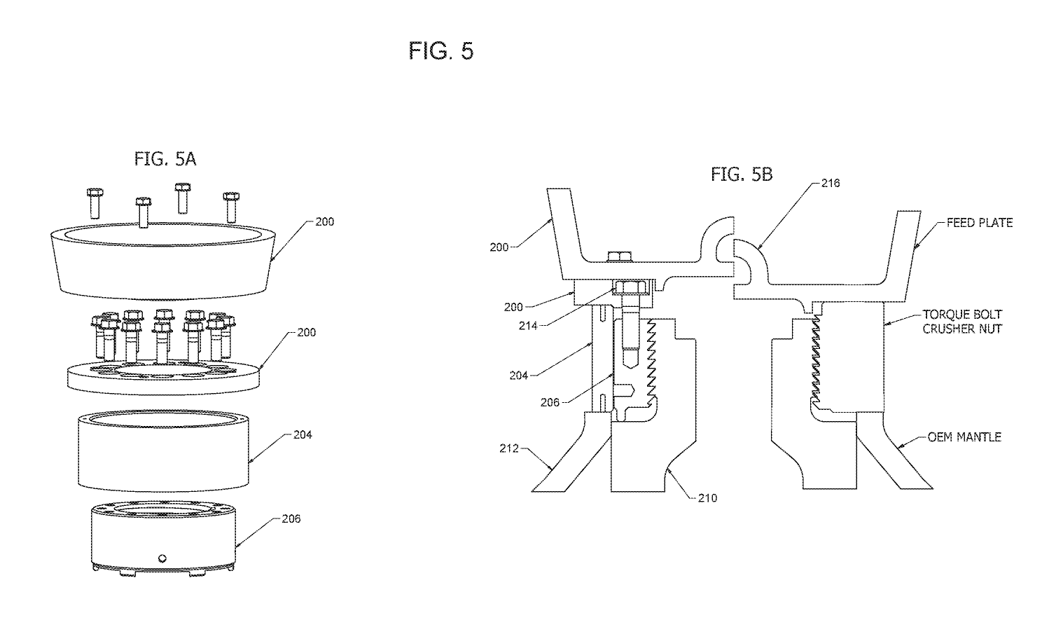

In another embodiment of the inventive mantle clamp assembly, FIGS. 5A and 5B show a design for the Metso MP-1000 cone rock crusher. FIG. 5A is an exploded view of the inventive mantle clamp assembly with the feed plate assembly 202, mantle clamp 200, wear ring 204, and threaded inner nut 206

FIG. 5B is a schematic cross section comparing the new embodiment on the left and the OEM design on the right. In this embodiment, the inner nut 206 has internal threads for semi-permanent installation on main shaft 210. The stronger wear ring 204 protects the inner nut 206 by sliding down over the outside of the inner nut to sit on the OEM. The new clamp plate 200 sits on top of the wear ring 204 and has holes to accommodate clamp bolts 214 that are screwed into the inner nut 206. The OEM design can be expected to wear more quickly as it positions a single threaded nut to interface with the head and with the cascading rocks. Notice that the feed plate 200 has a lifting eye 216 that will be given a custom design. Our new design better accommodates a skewed mantle or one that does not have an even surface because the clamp bolts can be tightened variable heights on one side or another. The OEM has only a nut that screws to the same height on all sides.

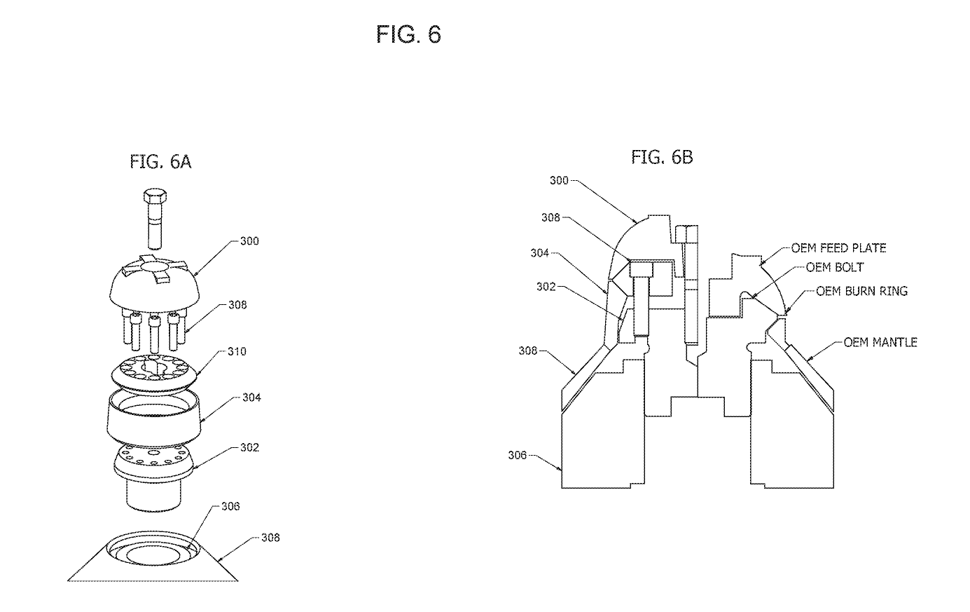

In another embodiment, FIGS. 6A and 6B show a new design of the mantle clamp for the HP-800 rock crusher. FIG. 6A is an exploded view of the inventive mantle clamp assembly with a feed plate assembly 300, inner bolt 302, wear ring 304, as well as OEM head 306 and mantle 305.

FIG. 6B is a schematic cross section comparing the new embodiment on the left and the OEM design on the right. The inner bolt 302 is semi-permanently screwed into the head 306, which eliminates one step in rebuilding. Next the mantle 308 is placed over the head 306 and centered. Then the wear ring 304 slides down over the inner bolt 302. The wear ring 310 is placed on top of the burn ring 304 and fitted over the inner bolt 302. Clamp bolts 308 are placed in the holes in the clamp plate and screwed down into the inner bolt 302 to lock the mantle 308 in place. Like FIG. 5B the clamp bolts 308 here can be screwed to different heights to accommodate an uneven mantle 308.

### Example 1

We tested the device shown in FIGS. 2A and 2B (left) at a large copper mine employing the Symons 7″ Shorthead Cone Crusher. First, the customer used a battering ram and welding torch to remove the old torque bolt crusher nut. As mentioned above, that was time-consuming and dangerous to manually guide a battering ram to hit the exact part to be removed.

Operators then installed the embodiment of FIGS. 2A and 2B (left). The customer reported that the installation was safer, simple and straightforward—and done in less than one half of the typical time (with different threads, it could be as little as one fifth of the time). Next 320 tons of ore were processed. Following the ore processing, this embodiment of our invention was removed more easily than previously, without use of battering ram or welding torch. The customer inspected the device and reported no significant wear. The customer elected to reinstall and to continue use of this embodiment of the invention in rock processing.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” and “example,” and similar language throughout this specification may, but do not necessarily, all refer to the same embodiment, to different embodiments, or to one or more of the figures. Additionally, reference to the words “embodiment,” “example” or the like for two or more features, elements, etc., does not mean that the features are necessarily related, dissimilar, the same, etc.

Each statement of an embodiment or example is to be considered independent of any other statement of an embodiment despite any use of similar or identical language characterizing each embodiment. Therefore, where on embodiment is identified as “another embodiment,” the identified embodiment is independent of any other embodiments characterized by the language “another embodiment.” The features, functions and the like described herein are considered to be able to be combined in whole or in part one with another as the claims and/or art may direct, either directly or indirectly, implicitly or explicitly.

Reference throughout this specification to features, advantages, or similar language does not imply that all of features and advantages that may be realized with the present invention should be or are in any single embodiment of the invention. Rather, language referring to the features and advantages is understood to mean that a specific feature, advantage or characteristic described in connection with an embodiment is included in at least one embodiment of the present invention. Thus, discussion of the features and advantages, and similar language, throughout this specification may, but does not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications and improvements are within the scope of the present invention.

1. A mantle clamp configuration designed to lock the mantle in place on a rock crusher, the configuration comprising
a) a mantle clamp assembly comprising
i) a clamp plate with holes;
ii) a plurality of clamp bolts that are inserted through the holes; and
iii) optionally a dust cover with dust cover bolts;
b) modified original equipment manufacturer (OEM) assembly comprising
i) modified locking collar;
ii) new locking collar bolts to accept the clamp bolts; and
iii) wear ring modified to fit the overlying clamp plate.

2. The mantle clamp configuration of claim 1 wherein the dust cover covers the clamp bolts and is held in place by dust cover bolts.

3. The mantle clamp configuration of claim 1, wherein the wear ring is omitted.

4. A mantle clamp configuration designed to lock the mantle in place on a rock crusher, the configuration comprising
a) an inner nut installed above the mantle and head, the inner nut having a plurality of holes to accept a plurality of clamp bolts;
b) an outer wear ring that slides over the inner nut; and
c) a clamp plate assembly comprising
i) a clamp plate with a top and a bottom, the bottom having a plurality of holes; and
ii) a plurality of clamp bolts.

5. The mantle clamp configuration of claim 4 wherein the clamp plate is hollow and has a wider top surface and a narrower lower portion to fit inside the outer wear ring.

6. The mantle clamp configuration of claim 4 wherein the clamp plate has hollow central cylinder, where the clamp bolts are accessed.

7. The mantle clamp configuration of claim 4 wherein the wider top surface of the clamp plate supports a feed plate.

8. A mantle clamp configuration to lock a mantle in place on a rock crusher, the configuration comprising
a) an inner nut with its inside circumference threaded to fit an OEM head and a top with a plurality of holes to receive clamp bolts;
b) a wear ring with a larger circumference than the inner nut and designed to slide over and protect the inner nut;
c) a feed plate assembly comprising
i) a feed plate with raised edges and a central lifting eye; and
ii) a plurality of clamp bolts that project downward from the feed plate and that are screwed into the inner nut; and
d) a cover plate that sits within the raised sides of the fee plate and covers and protects the clamp bolts.

9. A mantle clamp configuration to lock a mantle in place on a rock crusher, the configuration comprising
a) an inner bolt sized to fit in a hollow, threaded OEM head and having a top surface with a plurality of holes to accept clamp bolts;
b) a feed plate assembly comprising
i) a feed plate with raised edges and a plurality of holes; and
ii) a plurality of clamp bolts that enter the feed plate holes and are screwed into the holes in the inner bolt.
